(19) United States
(12) Patent Application Publication
(10) Pub. No.: US 2003/0189009 A1
(43) Pub. Date: Oct. 9, 2003

(54) Method for concentrating ions in a solution

(76) Inventor: Stephen R. Wurzburger, Goodyear Bar, CA (US)

Correspondence Address: Robert Samuel Smith, 1263 EMORY ST., SAN JOSE, CA, 95126, US

(21) Appl. No.: 10/117,878

(22) Filed: Apr. 6, 2002

(51) Int. Cl. B01D 59/50

(52) U.S. Cl. 210/737

(57) ABSTRACT

A method for increasing concentration a solution of ions in a solvent which includes the steps of reducing the temperature of the solution to a temperature slightly below the freezing temperature of the pure solvent, mechanically breaking up the frozen portion of the partially frozen solution so as to form a slush, separating the frozen portion from the ion enriched liquid filtrate.

### FIELD OF THE INVENTION

This invention relates to methods for concentrating ions in a solution and particularly to a method of separation by partially freezing the solution and separating the liquid and solid portions by filtration.

### BACKGROUND AND INFORMATION DISCLOSURE

A number of chemical processes require concentration of ion species in a solution(usually aqueous) where the beginning point is a dilute concentration. The usual operation is distillation where the concentration is accomplished by permitting the solvent to partially evaporate. In some instance, heat is applied to hasten the removal of liquid thereby increasing the concentration of ions I the remaining liquid. Oftentimes, application of heat is not satisfactory for any one of a number of reasons. One reason is that energy is required to raise the temperature of the solution to a distillation temperature. Another reason is the necessity of disposing of escaping vapors, Another method is by chemical methods.

Solutions of particular interest are aqueous solutions of hydronium ions (H₃O⁺) and aqueous solutions of ions containing activated oxygen radicals.

In a report by H. Hayashi, director, published by the Water Institute, Tokyo, Japan, (incorporated herein by reference) there is disclosed generation of “acid” water and “base” water by electrolysis. The apparatus comprises a porous membrane between an anode and a cathode. By appropriate selection of anode, cathode and membrane material, an “acid” water containing activated hydrogen ions are generated at the anode and a “base” water containing activated oxygen ions are generated at the cathode. The acid water is characterized by a high oxidation potential and the base water is characterized by a high reduction potential.

U.S. Pat. No. 5,380,838 discloses a chemical method for generating a hydronium solution.

Motivation for increasing the ion concentration in an aqueous solution is present particularly in the application of electrolytic techniques to produce the solution with the highest concentration of free protons.

### SUMMARY OF THE INVENTION

It is an object of this invention to increase the concentration of ions in a solution of the ions in a solvent.

It is contemplated that the concentration of ions be accomplished without the application of heat such as required in high temperature distillation processes.

It is a further object that the process be continuously repetitive until the limit of solubility of the ions in the solution is reached.

Still another object is to apply the method of this invention to the generation of a pure and concentrated aqueous solution of hydronium ions.

This invention is directed toward a method for concentrating ions in a solution of the ions in a solvent by reducing the temperature of the solution to a temperature that is just below the freezing temperature of the pure solvent. In this condition, it is found that a portion of the solution will solidify leaving another portion of the solution that is liquid. The entire solution (including frozen and liquid portions) is then passed though a filter to separate the solid portion from the liquid portion. The liquid portion has an increased concentration of ions and the solid portion has a decreased portion of ions.

The method has particular application to enriching aqueous solutions of hydronium ions.

### BRIEF DESCRIPTION OF THE DRAWINGS

FIG. 1 is a flow chart listing steps in practicing the method of this invention.

FIG. 2A is a flow chart listing the steps for preparing a solution of hydronium ions.

FIG. 2B is a flow chart listing the steps including freezing for concentrating the solution of hydronium ions of FIG. 2A.

FIG. 3 is a schematic diagram of an apparatus for performing the steps of FIG. 2B.

### DESCRIPTION OF BEST MODE

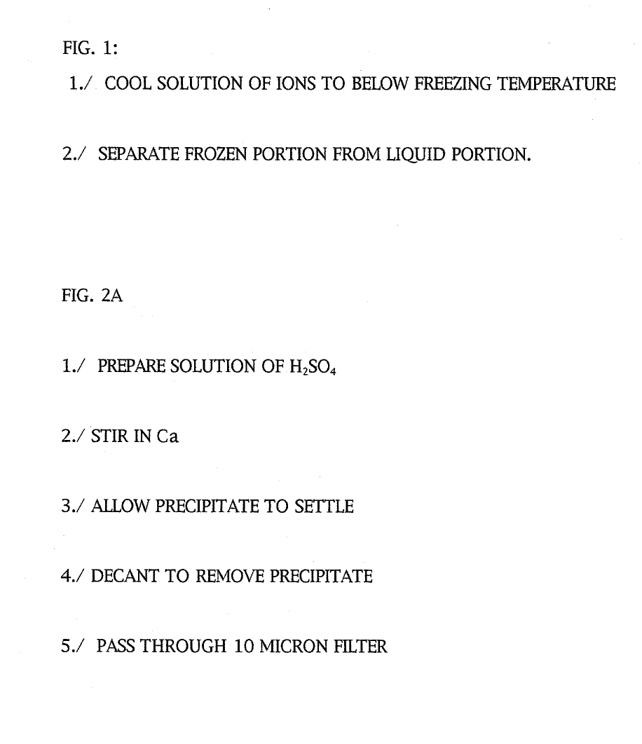

Turning now to a discussion of the drawings, FIG. 1 lists the steps of the method of the invention for concentrating ions in a solution.

In step 1, the solution is placed in a container and the temperature of the solution is reduced to a temperature that is just below the freezing temperature of the pure solvent so that the solution becomes “slushy”. One portion of the solution has solidified leaving a second portion that is liquid. The second portion has a greater concentration of ions than the first portion as a result of the partial freezing step.

In step 2, the solution of solid and liquid is passed through a filter that separates the solid portion from the liquid portion.

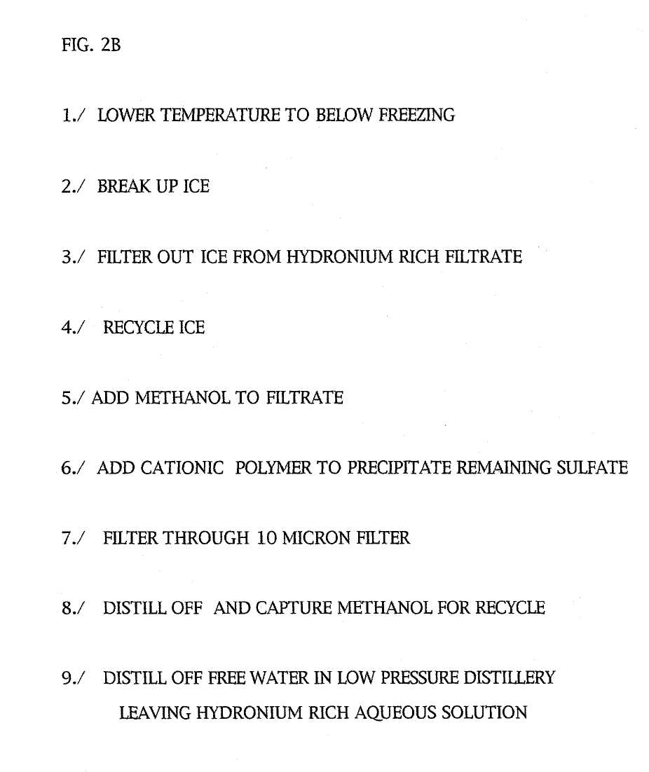

FIGS. 2A, B is a two part flow chart listing the steps for preparing a concentrated solution of hydronium ions.

FIG. 2A (the first part) lists the steps for generating the hydronium ions.

In step 1, reagent grade concentrated sulfuric acid (98%) is added to distilled H₂O so as to create a solution being 1.5 to 2.0 mole of sulfuric acid in water. This solution is permitted to mix for sufficient time to allow total dissociation of H₂SO4 into H₃O⁺ ions and SO₄⁻ ions.

In step 2, a gram mole equivalent (1.5 to 2.0 moles) of reagent grade calcium metal turnings or calcium hydride (CaH₂) is slowly added to the solution. The solution is mixed until the reaction goes to completion and the solution cools to below 100° F.

In step 3, the solution is immobilized whereby most of the precipitated calcium sulfate settles on the bottom of the mix tank.

In step 4, the solution is decanted to separate the settled precipitate from the solution.

In step 5, the decanted solution is passed through a 10 micron fiberglass filter to separate out remaining particulates of calcium sulfate.

FIG. 2B is a flow chart of the second part of the process to complete concentration of the hydronium ions.

In step 1, the filtered solution is placed in a high strength nalgene container of one to five gallons and placed in a freezing device so as to reduce the temperature to 25-28° F. The solution is thereby converted to a slush.

In step 2, the slush is broken up by mechanical agitation.

In step 3, the slush is passed through a filter (preferably a 50 micron fiber glass screen) to separate the ice from the liquid water. About ⅔ of the solution is ice and the remaining ⅓ of the solution (the hydronium concentrate) is liquid and passes through the filter.

In step 4, the ice is melted in preparation to making the next batch of hydronium solution. This involves adding sufficient water and sulfuric acid to the solution of melted ice to restore the volume and gram molar strength of step 1 of FIG. 2A to become the starting acid solution of the method of FIG. 2A for the next batch.

In step 5. the filtrate is placed in measuring containers. A measured volume of methanol is added to the concentrate according to 3 parts methanol to 7 parts hydronium ion concentrate. The mixture is stirred whereby most of the calcium sulfate crystallizes.

In step 6, sufficient cationic polymer is added to capture remaining sulfate ions.

In step 7, the solution is poured through a 10-micron fiberglass filter to remove the sulfate-polymer particulates.

In step 8, the hydronium—alcohol concentrate (4.5 to 5.0 moles per liter) is placed in a distillation unit to remove and recover a major portion of the methanol for reuse.

In step 9, the remaining solution is placed in a second batch, low temperature—low pressure distillation unit, and operated until all free water molecules have been removed by distillation. Vapor from the distillation step is permitted to condense and the condensate is added to the starter batch mixture. This eliminates discharge cost and permits recovery of any hydronium ions that have been driven off by the distillation process.

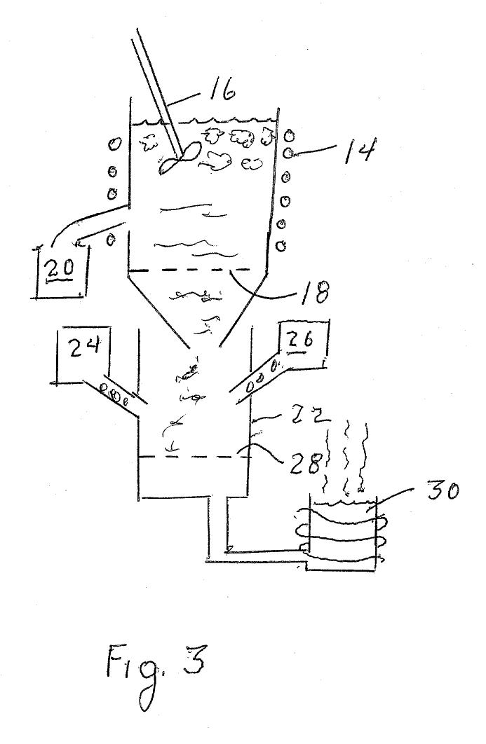

FIG. 3 shows an apparatus constructed according to the invention for performing the steps in FIG. 2B. There is shown a container 12 with cooling coils 14 to freeze the solution. An agitator 16 is shown for breaking the ice—water to a slush consistency. The liquid portion is separated from the ice by draining through a filter 18. The remaining ice is then permitted to melt and be drained into a separate container 20 for reuse. The hydronium rich liquid separated from the ice is drained into a separate container 22 where methanol 26 is added and cationic polymer 24 is added forming a precipitate of remaining sulfates. The precipitate is removed by filter 28. Methanol and free water is removed in distillery 30

When this process has gone to completion, the hydronium concentrate has a viscosity of light oil.

Tests by independent laboratories have shown that the concentrate has a proton concentration equivalent to a solution of sulfuric acid greater than 19 moles/liter.

There has been disclosed a method and apparatus for separating a solution into two fractions wherein one fraction has a greater concentration of ions than the other fraction. This technique has been applied to generating an aqueous solution of concentrated hydronium ions.

The method has been described as taking place in two steps. In the first step, hydronium ions are generated by interaction between a group IIA metal and an oxidizing acid followed by removal of the resulting precipitates. The filtrate is a solution with a large concentration of hydronium ions. The preferred group IIA metal is Calcium but other group II A metals such as Barium will also serve the same purpose. The preferred oxidizing acid is sulfuric acid but other acids would also be expected to perform the same function. The important requirement is that the metal salt formed in the mixing process be virtually insoluble so that residual metal cations and acid anions are removed by filtration.

The second step involves reducing the temperature of the filtrate to a temperature just below the freezing temperature of pure water. The solution containing ice is gently agitated whereby the solution becomes a “slush” containing liquid (water) and solid (ice). The water contains a heavy concentration of hydronium ions. The ice (containing the lesser concentration of hydronium ions) is separated from the water (having the greater concentration of hydronium ion) in accordance with the object of the process.

While we do not wish to be bound by theory, it is believed that the separation of the ice and liquid fractions in a temperature range just below freezing temperature of pure water results from the natural random variation of ion concentration within the water body. It is well known that (liquid) water exists as “clusters” of water molecules—not as discreet molecules of H₂O independent from one another, “Natural” water has a cluster size of about thirteen microns. The cluster size depends on various treatments of the water. For example, water that has been involved in electrolysis has been found to have a cluster size of about three microns. It is reasonable to expect that there will be at least a random distribution of ion concentration, (specifically hydronium ion concentration) among the clusters that compose the filtrate of this invention. Clusters that have the highest concentration of ions would tend to attract one another according to well known theory related to polarizable matter. The filtrate would therefore behave like a mixture of two phases of different ion concentrations. As observed, and expected from classical theory of solutions, the liquid phase has a greater ion concentration (and therefore a lower freezing temperature) than the ice phase so that filtering out the ice effectively separates the ice, having a smaller concentration of ions, from the liquid, having the larger concentration of ions.

A modest concentration of hydronium ions will be found in the ice phase so that it is economical to melt and recycle the ice phase from a first batch into a making of a second batch by adding the appropriate amounts of Ca, and sulfuric acid in accordance with the invention.

The hydronium ion concentrate of this invention has numerous applications where positive ions are required and particularly where the presence of anions such as sulfates and phosphates are undesireable, These applications are all within the scope of the invention.

There has been described a method and apparatus for separating a solution containing ions in a solvent into two fractions wherein one fraction contains a greater concentration than the other fraction. The separation is achieved by maintaining the temperature of the solution in a range slightly lower than the freezing temperature of the pure solvent so that a portion of the solution freezes and can be separated from a liquid portion. The liquid portion will have a greater ion concentration than the frozen portion. The freezing technique can be repeated on either or both portions thereby substantially increasing the degree of concentration.

The technique is applicable to a great many ionic solutions for various objectives.

One example has been described for formulating a concentrated solution of hydronium ions. Such solutions have been disclosed as being useful where strong proton activity is required as indicated by a large reduction potential.

Tests by independent laboratories have shown that the hydronium concentrate produced by applying the steps described herein has a proton concentration equivalent to a solution of sulfuric acid greater than 19 moles/liter.

The hydronium ion concentrate of this invention has numerous applications where positive ions are required and particularly where the presence of anions such as sulfates and phosphates are undesireable, Use of the concentrate in these applications are all within the scope of the invention.

Variations and modifications of the method and apparatus suggested by reading the specification are within the scope of the invention. For example, the frozen and liquid portions of the solution may be separated by centrifuging the solution or by a combination of filtering and centrifuging. We therefore wish to define the scope of the invention by the appended claims.

What is claimed is:

1. A method for concentrating ions in a solution of said ions in a solvent which comprises the steps:
(i) reducing the temperature of said solution to a temperature range that is below a freezing temperature of said solvent where one portion of said solution is frozen and has a greater concentration of said ions and another portion of said solution is liquid and has a lesser concentration of said ions;
(ii) separating said one portion that is frozen from said another portion which is liquid.

2. The method of claim 1 wherein said solution is an aqueous solution.

3. The method of claim 2 wherein and said temperature range is 25° F. to 32° F.

4. The method of claim 2 wherein said ions are hydronium ions.

5. The method of claim 1 wherein said step (ii) includes the step of passng said solution at said reduced temperature through a filter selected to separate said frozen portion from said liquid portion.

6. The method of claim 1 wherein said step (ii) includes the step of centrifuging said solution at said reduced temperature arranged to separate said frozen portion from said liquid portion.

7. A method for forming a concentrated solution of ions in a solvent, said solvent having a freezing temperature when said solvent is pure, said method comprising the steps:
(i) mixing one constituent in said solvent,
(ii) mixing another constituent in said solvent in an amount equal to a mole equivalent of said one constituent wherein said one constituent and said another constituent are selected to result in formation of a precipitate of said one constituent compounded with said another constituent and result in formation of said ion in said solvent;
(iii) removing said precipitate from said solution leaving said solution containing said ions in said solution;
(iv) reducing the temperature of said solution to a temperature range that is below said freezing temperature and where one portion of said solution is frozen and has a greater concentration of said ions in said solvent and another portion of said solution is liquid and has a lesser concentration of said ions in said solvent;
(v) separating said one portion that is frozen from said another portion which is liquid.

8. The method of claim 7 wherein:
said solvent is water; and
said step (i) includes a step of mixing n moles of sulfuric acid in said water;
said step (ii) includes a step of mixing n moles of calcium in said water whereby said precipitate that is formed is calcium sulfate;
said step (iii) including a step of removing said precipitate of calcium sulfate from said solution leaving said solution being said water containing hydronium ions;
said steps (iv) and (v) providing said one portion of solution having said greater concentration of hydronium ions and said another portion containing a lesser concentration of hydronium ions.

9. The method of claim 8 wherein n has a value selected from a range being 1.5 to 2.0. in a liter of water and said precipitate is calcium sulfate.

10. The method of claim 9 wherein said step (iii) comprises decanting solution from settled precipitate and filtering said solution through a ten micron fiber glass filter.

11. the method of claim 10 wherein said temperatue range is 25 to 28° F.

12. The method of claim 11 wherein said step (v) comprises:
(v.a) gently agitating said solution whereby a slush of said one portion and another portion is generated;
(v.b) applying a filter to separate said one portion, being liquid containing a greater concentration of hydronium ions, from said another portion, being solid containing a lesser concentration of hydronium ions.
(v.c) adding methanol to said one portion according to 3 parts methanol to 7 parts said one portion causing most of calcium sulfate in said first portion to crystallize;
(v.d) adding an amount of cationic polymer to said one portion in an amount selected to capture remaining sulfate ions;
(v.e) pouring said first portion through a filter whereby sulfate-polymer particulates are removed;
(v.f) distilling and collecting said methanol from said one portion;
(v,g) distilling and collecting free water from said one portion;

13. The method of claim 12 whereby said filter of step (v.e) is a 10 micron fiber glass filter.

14. A method for forming a concentrated aqueous solution of hydronium ions comprising the steps:
(i) placing said water in an a container including an ion membrane filter between a cathode in a cathode chamber and an anode in an anode chamber;
(ii) passing electrical current between said cathode and said anode whereby hydronium enriched aqueous solution is generated in said anode chamber.
(iii) reducing the temperature of said hydronium enriched aqueous solution to a temperature selected from the range between 25° F. and 28° F. and where one portion of said aqueous solution is liquid and has a greater concentration of hydronium ions and another portion is solid and has a lesser concentration of said ions in said solvent;
(iv) separating said one portion which is liquid and hydronium ion enriched from said another portion which is frozen.

15. An apparatus for increasing concentration of hydronium ions in an aqueous solution by removing water from said aqueous solution, said apparatus comprising:
a container arranged for holding said solution;
means for reducing temperature of said solution in said container to a temperature selected from a range between 25° F. to 28° F. wherein one portion of said solution remains liquid and another portion of said solution is frozen;
means for agitating said solution whereby said said another portion is dispersed in said first portion;
means for filtering said another portion from said one portion;
